(19) United States
(12) Patent Application Publication
(10) Pub. No.: US 2015/0215483 A1
(43) Pub. Date: Jul. 30, 2015

(54) Systems, Devices, and/or Methods for Managing Photography

(71) Applicant: Joshua Taylor Farnsworth, Charlottesville, VA (US)

(72) Inventor: Joshua Taylor Farnsworth, Charlottesville, VA (US)

(21) Appl. No.: 14/165,474

(22) Filed: Jan. 27, 2014

(51) Int. Cl. H04N 1/00; G03B 17/56; F16M 13/02

(52) U.S. Cl. CPC H04N 1/00541; F16M 13/02; H04N 1/00559; G03B 17/566

(57) ABSTRACT

Certain exemplary embodiments can provide a gripper. The gripper can be adapted to releasably couple a personal digital assistant to a camera system via a first jaw and a second jaw. The first jaw and the second jaw can comprise a grip end and a hand-grip end. The first jaw and the second jaw can be coupled at a pivot point.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a side view of an exemplary embodiment of a system 1000;

FIG. 2 is a front view of an exemplary embodiment of a system 2000;

FIG. 3 is a front view of an exemplary embodiment of a system 3000;

FIG. 4 is a front view of an exemplary embodiment of a system 4000;

FIG. 5 is a side view of an exemplary embodiment of a system 5000;

FIG. 6 is a side view of an exemplary embodiment of a system 6000;

FIG. 7 is a front view of an exemplary embodiment of a system 7000;

FIG. 8 is a front view of an exemplary embodiment of a system 8000;

FIG. 9 is a side view of an exemplary embodiment of a system 9000;

FIG. 10 is a side view of an exemplary embodiment of a system 10000;

FIG. 11 is a front view of an exemplary embodiment of a system 11000;

FIG. 12 is a front view of an exemplary embodiment of a system 12000;

FIG. 13 is a side view of an exemplary embodiment of a system 13000;

FIG. 14 is a side view of an exemplary embodiment of a system 14000;

FIG. 15 is a side view of an exemplary embodiment of a system 15000;

FIG. 16 is a side view of an exemplary embodiment of a system 16000;

FIG. 17 is a front view of an exemplary embodiment of a system 17000;

FIG. 18 is a front view of an exemplary embodiment of a system 18000;

FIG. 19 is a front view of an exemplary embodiment of a system 19000;

FIG. 20 is a side view of an exemplary embodiment of a system 20000;

FIG. 21 is a flowchart of an exemplary embodiment of a method 21000; and

FIG. 22 is a block diagram of an exemplary embodiment of an information device 22000.

### DETAILED DESCRIPTION

Certain exemplary embodiments can provide a gripper. The gripper can be adapted to releasably couple a personal digital assistant (PDA) to a camera system via a first jaw and a second jaw. The first jaw and the second jaw can comprise a grip end and a hand-grip end. The first jaw and the second jaw can be coupled at a pivot point.

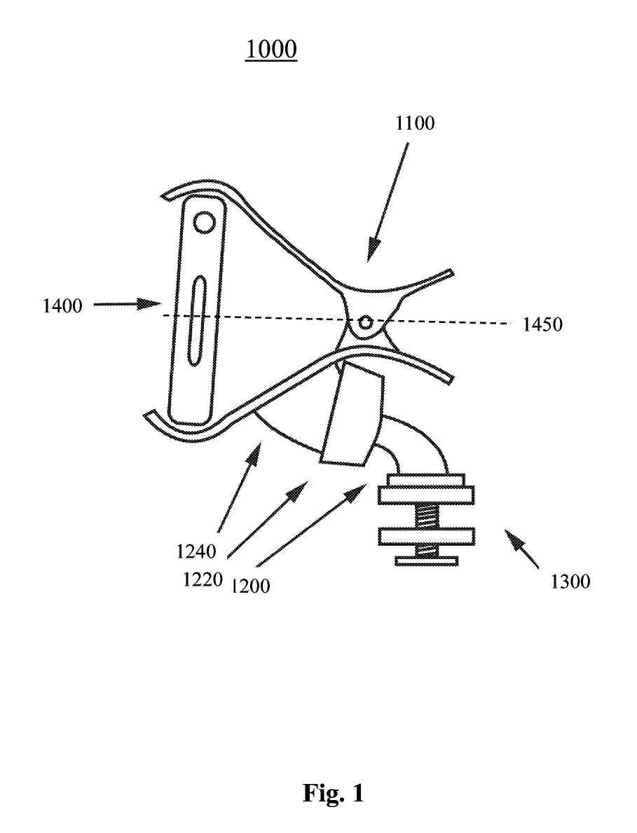

FIG. 1 is a side view of an exemplary embodiment of a system 1000, which can comprise a gripper 1100. Gripper 1100 can be adapted to releasably couple a PDA (e.g., a smartphone) 1400 to a camera system such that the face of PDA 1400 is substantially perpendicular to an axis 1450 of gripper 1100. System 1000 can comprise a coupling 1300, which can be adapted to releasably couple gripper 1100 to a hot shoe of a camera. System 1000 can comprise an elbow 1220, a swivel joint 1220, and a gripper base 1240. Collectively elbow 1220, swivel joint 1220, and gripper base 1240 can be called an elbow assembly.

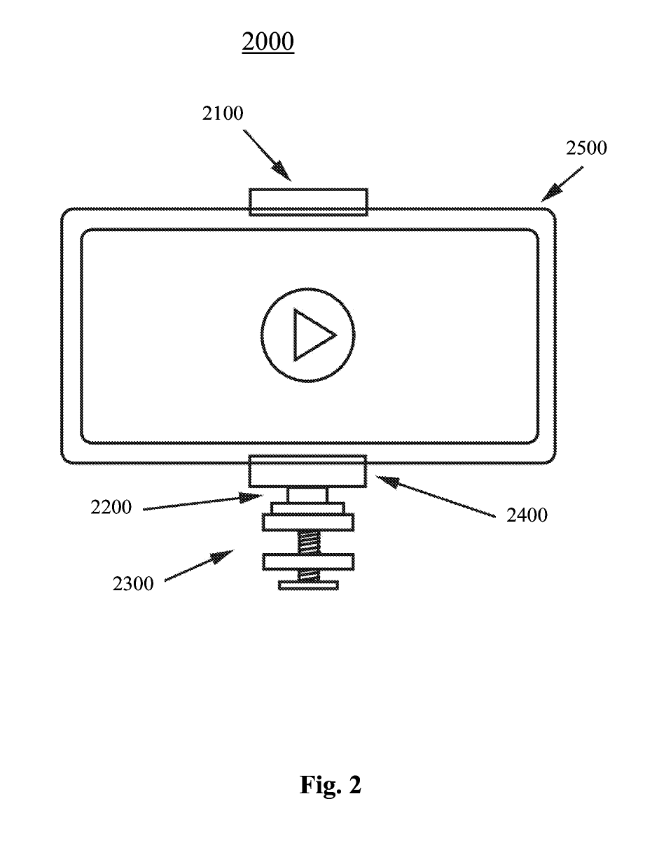

FIG. 2 is a front view of an exemplary embodiment of a system 2000, which can comprise a first jaw 2100 and a second jaw 2400. First jaw 2100 and second jaw 2400 can be adapted to releasably coupled to a PDA 2500 (e.g., a smartphone) to a camera system. System 2000 can comprise an elbow assembly 2200. System 2000 can comprise a camera mount 2300, which can be adapted to couple system 2000 to a hot shoe of a camera (not illustrated in FIG. 2).

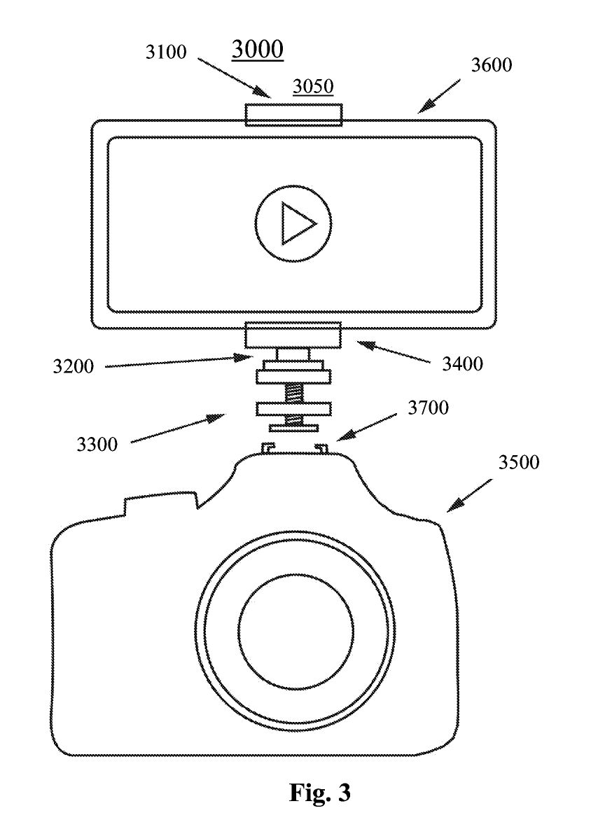

FIG. 3 is a front view of an exemplary embodiment of a system 3000, which can comprise gripper 3050. Gripper 3050 can comprise a first jaw 3100 and a second jaw 3400. First jaw 3100 and second jaw 3400 can be adapted to releasably couple a PDA 3600 to gripper 3050. System 3000 can comprise an elbow assembly 3200, which can be operatively coupled to second jaw 3400. Elbow assembly 3200 can be coupled to a camera mount 3300, which can be used to couple gripper 3050 to a camera 3500 via a hot shoe 3700 of camera 3500. A photographer can utilize PDA 3600 to show an image or play a video and thereby capture the attention of a subject being photographed. Focusing the attention of the subject being photographed on an image or video in proximity to camera 3500 can result in better photograph images of the subject.

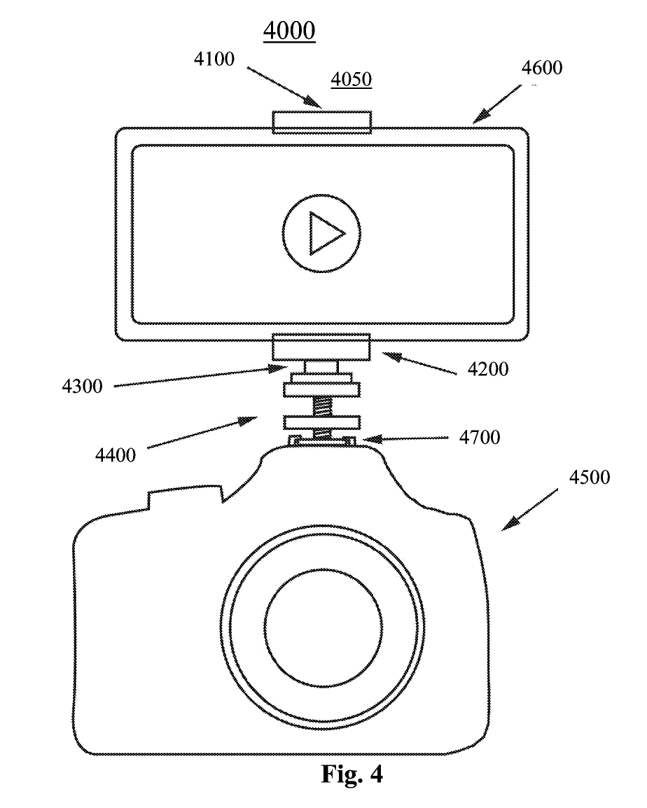

FIG. 4 is a front view of an exemplary embodiment of a system 4000, which can comprise gripper 4050. Gripper 4050 can comprise a first jaw 4100 and a second jaw 4200. First jaw 4100 and second jaw 4200 can be adapted to releasably couple a PDA 4600 to gripper 4050. System 4000 can comprise an elbow assembly 4300, which can be operatively coupled to second jaw 4200. Elbow assembly 4300 can be coupled to a camera mount 4400, which can be used to couple gripper 4050 to a camera 4500 via a hot shoe 4700 of camera 4500. A photographer can utilize PDA 4600 to show an image or play a video and thereby capture the attention of a subject being photographed.

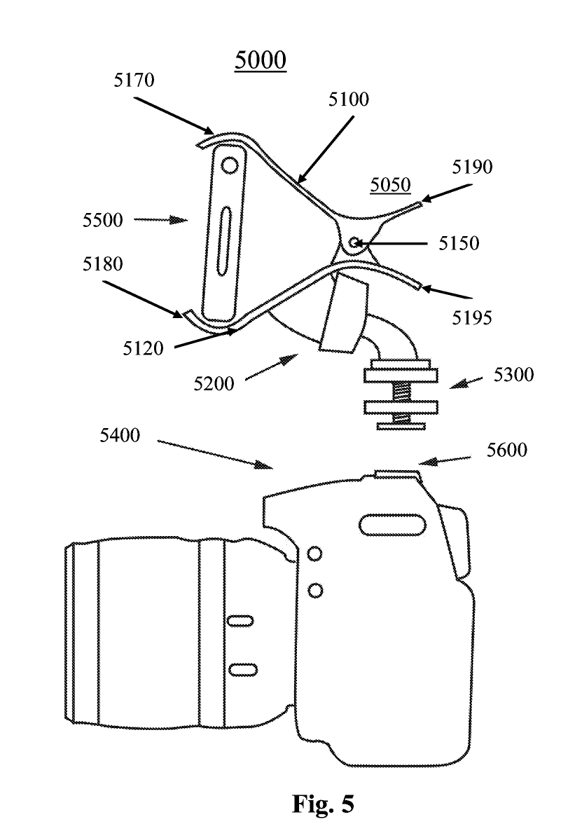

FIG. 5 is a side view of an exemplary embodiment of a system 5000, which can comprise a gripper 5050. Gripper 5050 can comprise a first jaw 5100 and a second jaw 5120. First jaw 5100 and second jaw 5120 can be coupled via a pivot point 5150. Pivot point 5150 is adapted to allow grip end 5170 of first jaw 5100 and grip end 5180 of second jaw 5120 to open when a user compresses a hand-grip end 5190 first jaw 5100 and hand-grip end 5195 of second jaw 5120. Pivot point 5150 can be adapted to cause an increased separation between grip end 5170 of first jaw 5100 and grip end 5180 of said second jaw 5120 when a user moves hand-grip end 5190 of first jaw 5100 toward hand-grip end 5195 of second jaw 5120. Gripper 5050 is adapted to releasably couple PDA 5500 (e.g., a smartphone) to a camera 5400. Via the coupling of gripper 5050 to camera 5400, PDA 5500 can face a subject of a photographer using camera 5400. PDA 5500 can be used to render images and/or video to hold the attention of the subject while photographs are being taken. Gripper 5050 can comprise an elbow assembly 5200, which can be adjustable to optimize visibility of a user interface of PDA 5500. System 5000 can comprise a camera mount 5300 via which gripper 5050 can be coupled to a hot shoe 5600 of camera 5400.

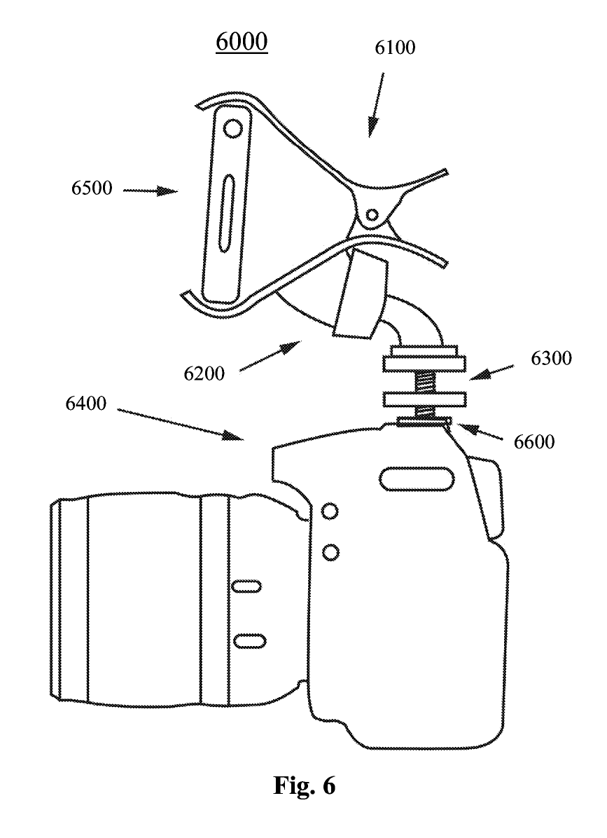

FIG. 6 is a side view of an exemplary embodiment of a system 6000, which can comprise a gripper 6100. Gripper 6100 is adapted to hold, retain, and couple a PDA 6500 (e.g., a smartphone) to a camera 6400. Via the coupling of gripper 6100 to camera 6400, PDA 6500 can face a subject of a photographer using camera 6400. PDA 6500 can be used to render images and/or video to hold the attention of the subject while photographs are being taken. Gripper 6100 can comprise an elbow assembly 6200, which can be adjustable to optimize visibility of a user interface of PDA 6500. System 6000 can comprise a camera mount 6300 via which gripper 6100 can be coupled to a hot shoe 6600 of camera 6400.

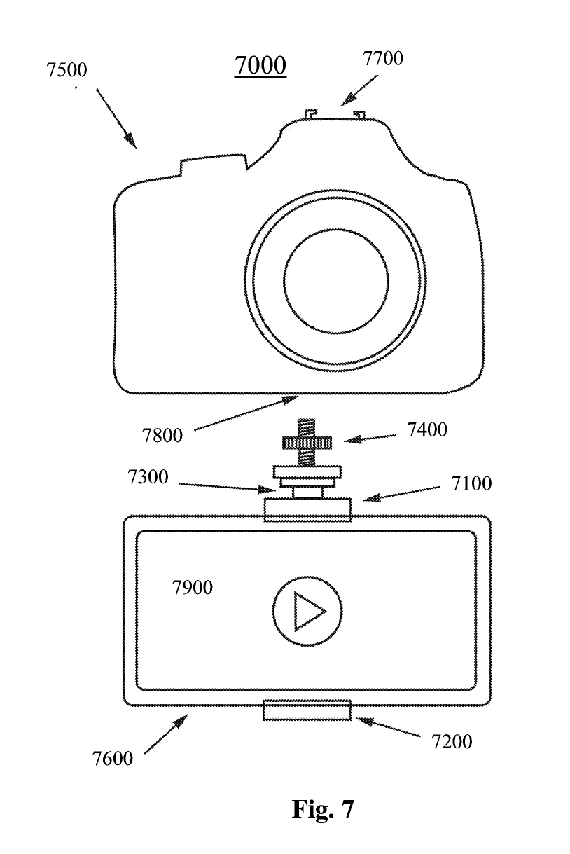

FIG. 7 is a front view of an exemplary embodiment of a system 7000, which can comprise a camera 7500. Camera 7500 can comprise a hot shoe 7700 and/or define a tripod mount 7800. In certain exemplary embodiments, tripod mount 7800 can be threaded and via the threads can be attached to a camera mount 7400 comprised by a gripper 7300. Gripper 7300 can comprise a first jaw 7100 and a second jaw 7200. Via first jaw 7100 and second jaw 7200, gripper 7200 can be adapted to couple a PDA 7600 to camera 7500. When operatively mounted to camera 7500, gripper 7300 can orient a face 7900 of PDA 7600 toward a subject in the viewfinder of camera 7500. Gripper 7300 can be adapted to orient PDA 7600 relative to camera 7500 such that face 7900 of PDA 7600 is viewable by a person viewed via a viewfinder of camera 7500.

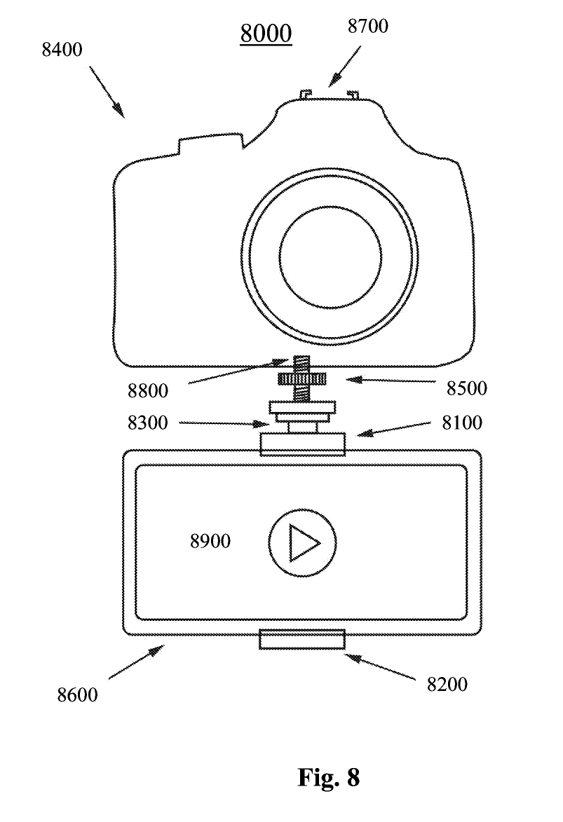

FIG. 8 is a front view of an exemplary embodiment of a system 8000, which can comprise a camera 8400. Camera 8400 can comprise a hot shoe 8700 and/or define a tripod mount 8800. In certain exemplary embodiments, tripod mount 8800 can be threaded and via the threads can be attached to a camera mount 8500 comprised by a gripper 8300. Gripper 8300 can comprise a first jaw 8100 and a second jaw 8200. Via first jaw 8100 and second jaw 8200, gripper 8300 can be adapted to couple a PDA 8600 to camera 8400. When operatively mounted to camera 8400, gripper 8300 can orient a face 8900 of PDA 8600 toward a subject in the viewfinder of camera 8400.

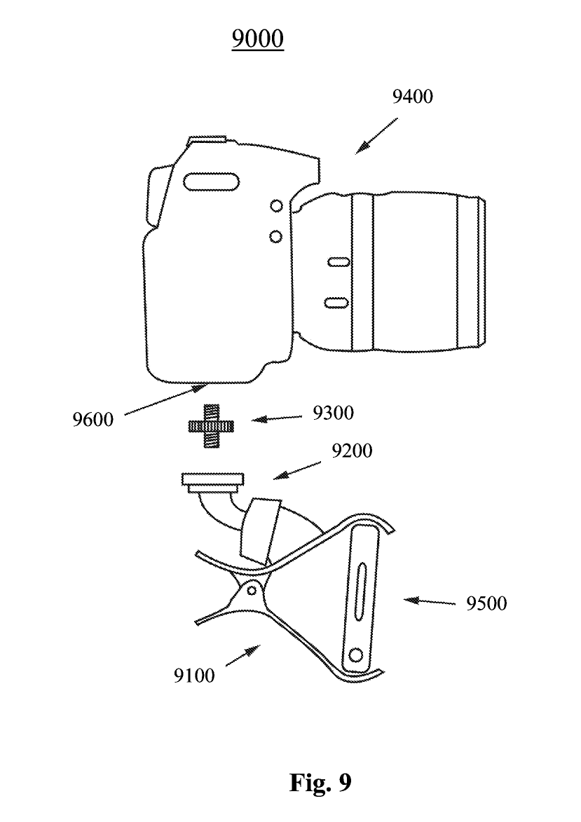

FIG. 9 is a side view of an exemplary embodiment of a system 9000, which can comprise a camera 9400. Camera 9400 can define a tripod mount 9600. In certain exemplary embodiments, tripod mount 9600 can be threaded and via the threads can be attached to a camera mount 9300 comprised by a gripper 9200. Gripper 9200 can comprise a set of jaws 9100, which can be adapted to hold a PDA 9500. When operatively mounted to camera 9400, gripper 9200 can orient a face of PDA 9500 toward a subject in the viewfinder of camera 9400.

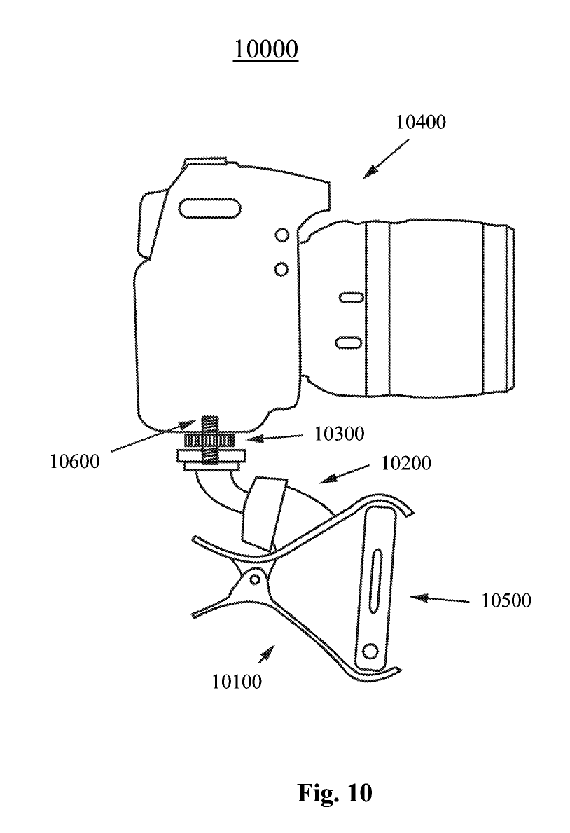

FIG. 10 is a side view of an exemplary embodiment of a system 10000, which can comprise a camera 10400. Camera 10400 can define a tripod mount 10600. In certain exemplary embodiments, tripod mount 10600 can be threaded and via the threads can be attached to a camera mount 10300 comprised by a gripper 10200. Gripper 10200 can comprise a set of jaws 10100, which can be adapted to hold a PDA 10500. When operatively mounted to camera 10400, gripper 10200 can orient a face of PDA 10500 toward a subject in the viewfinder of camera 10400.

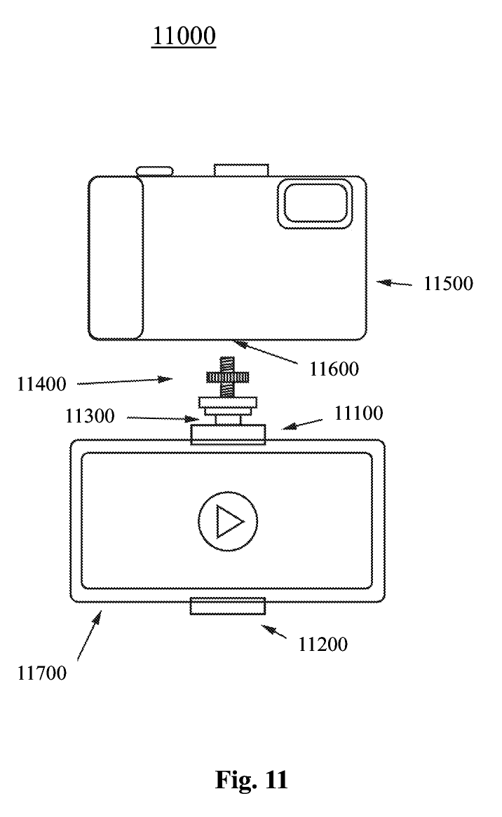

FIG. 11 is a front view of an exemplary embodiment of a system 11000, which can comprise a camera 11500. Camera 11500 can be a digital camera and can define a tripod mount 11600. In certain exemplary embodiments, tripod mount 11600 can be threaded and via the threads can be attached to a camera mount 11400 comprised by a gripper 11300. Gripper 11300 can comprise a set of jaws comprising a first jaw 11100 and a second jaw 11200, which can be adapted to hold a PDA 11700. When operatively mounted to camera 11500, gripper 11300 can orient a face of PDA 11700 toward a subject in the viewfinder of camera 11500.

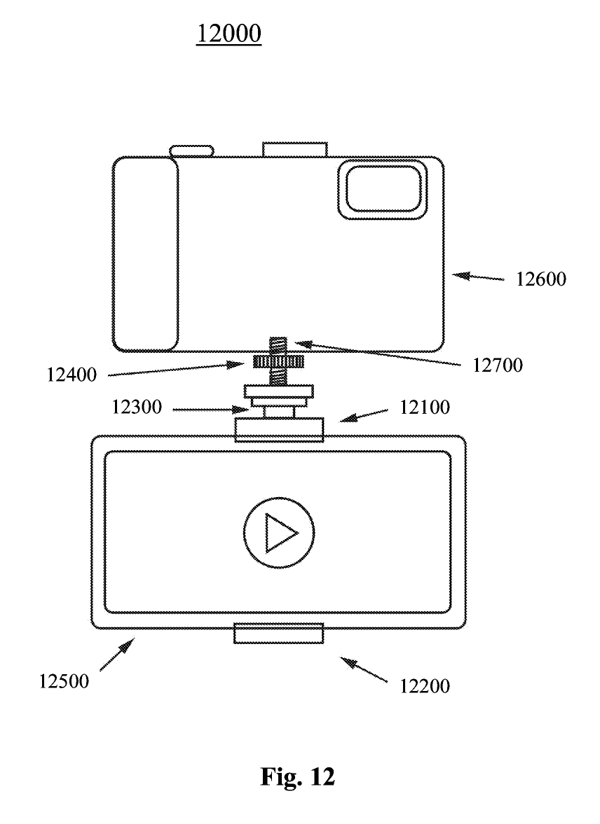

FIG. 12 is a front view of an exemplary embodiment of a system 12000, which can comprise a camera 12600. Camera 12600 can be a digital camera and can define a tripod mount 12700. In certain exemplary embodiments, tripod mount 12700 can be threaded and via the threads can be attached to a camera mount 12400 comprised by a gripper 12300. Gripper 12300 can comprise a set of jaws comprising a first jaw 12100 and a second jaw 12200, which can be adapted to hold a PDA 12500. When operatively mounted to camera 12600, gripper 12300 can orient a face of PDA 12500 toward a subject in the viewfinder of camera 12600.

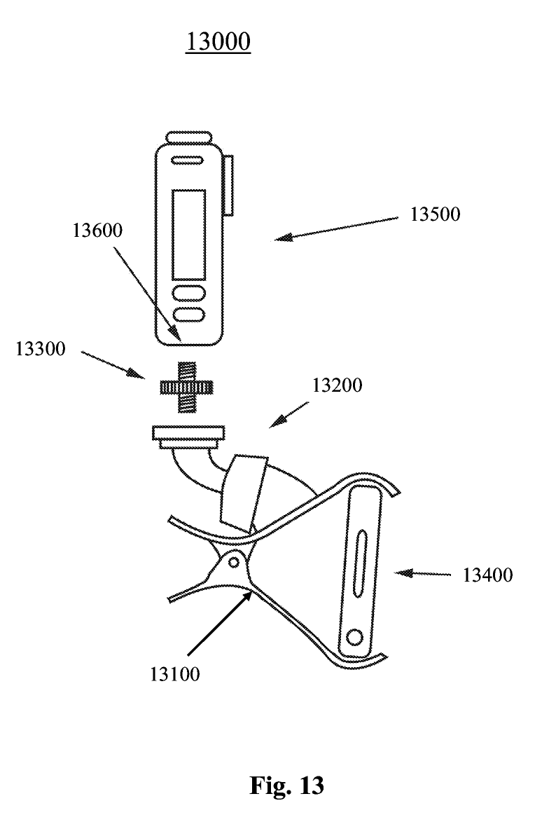

FIG. 13 is a side view of an exemplary embodiment of a system 13000, which can comprise a camera 13500. Camera 13500 can be a digital camera and can define a tripod mount 13600. In certain exemplary embodiments, tripod mount 13600 can be threaded and via the threads can be attached to a camera mount 13300 comprised by and/or operatively coupled to a gripper 13200. In the embodiment illustrated in FIG. 13, camera mount 13300 is a separate piece that can be coupled via threads to a jaw portion of gripper 13200. Gripper 13200 can comprise a set of jaws 13100, which can be adapted to hold a PDA 13400. When operatively mounted to camera 13500, gripper 13200 can orient a face of PDA 13400 toward a subject in the viewfinder of camera 13500.

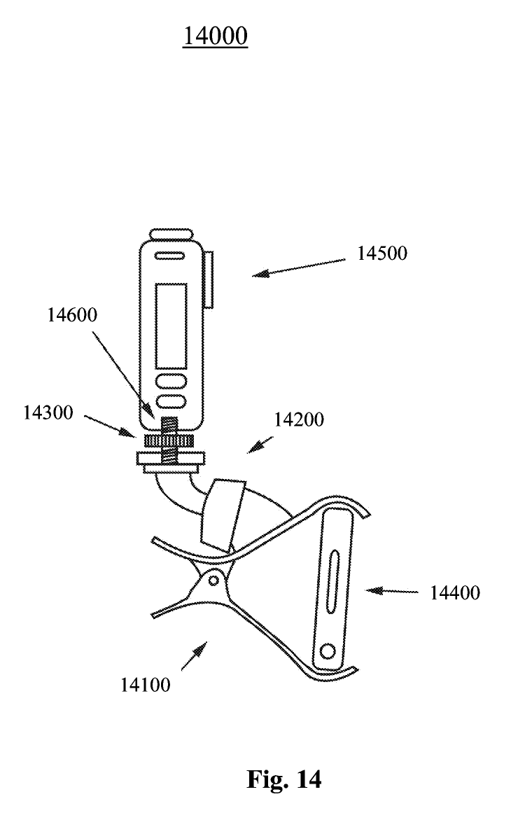

FIG. 14 is a side view of an exemplary embodiment of a system 14000, which can comprise a camera 14500. Camera 14500 can be a digital camera and can define a tripod mount 14600. In certain exemplary embodiments, tripod mount 14600 can be threaded and via the threads can be attached to a camera mount 14300 comprised by and/or operatively coupled to a gripper 14200. In the embodiment illustrated in FIG. 14, camera mount 14300 is a separate piece that can be coupled via threads to a jaw portion of gripper 14200. Gripper 14200 can comprise a set of jaws 14100, which can be adapted to hold a PDA 14400. When operatively mounted to camera 14500, gripper 14200 can orient a face of PDA 14400 toward a subject in the viewfinder of camera 14500.

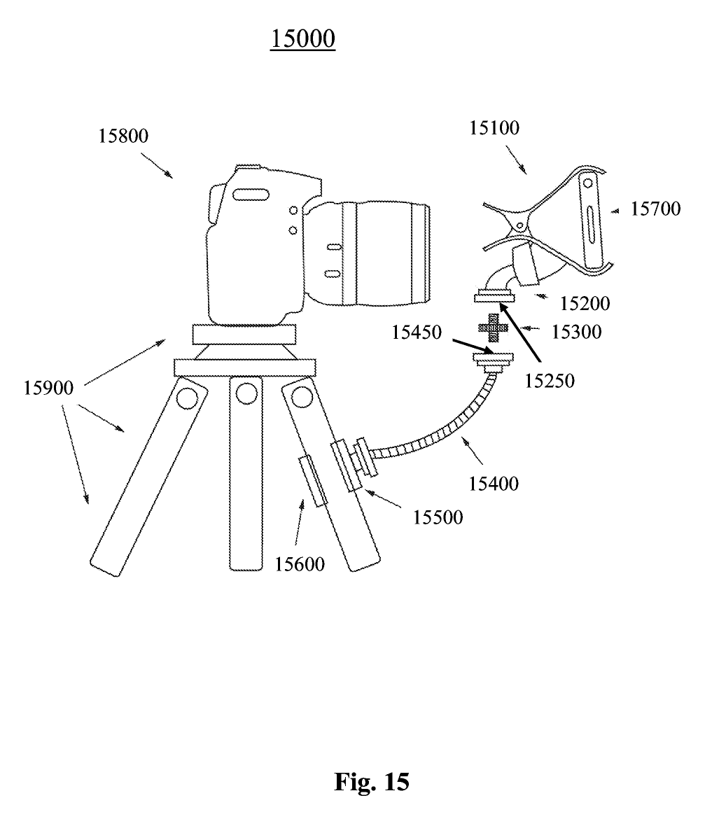

FIG. 15 is a side view of an exemplary embodiment of a system 15000, which can comprise a camera 15800 mounted to a tripod 15900. Camera 15800 can be a single lens reflex camera or any other type of camera. In certain exemplary embodiments, a gripper 15200 can be operatively coupled to a leg 15600 of tripod 15900 via a clamp 15500. Gripper 15200 can comprise a semi-rigid extension 15400. Semi-rigid extension 15400 can be adapted to support gripper 15200 and a PDA 15700 substantially without motion or deflection absent an outside force. Semi-rigid extension 15400 can be adjusted by a user to position and orient PDA 15700 according to desires of the user for photographs to be taken by camera 15800. Semi-rigid extension 15400 can define a threaded aperture 15450 and can, via threaded coupling 15300 be coupled to jaws 15100 of gripper 15200. Gripper 15200 can define a threaded aperture 15250, which can be adapted to be coupled to threaded coupling 15300. Jaws 15100 can be adapted to hold a PDA 15700. When operatively mounted to tripod 15900, gripper 15200 can orient a face of PDA 15700 toward a subject in the viewfinder of camera 15800.

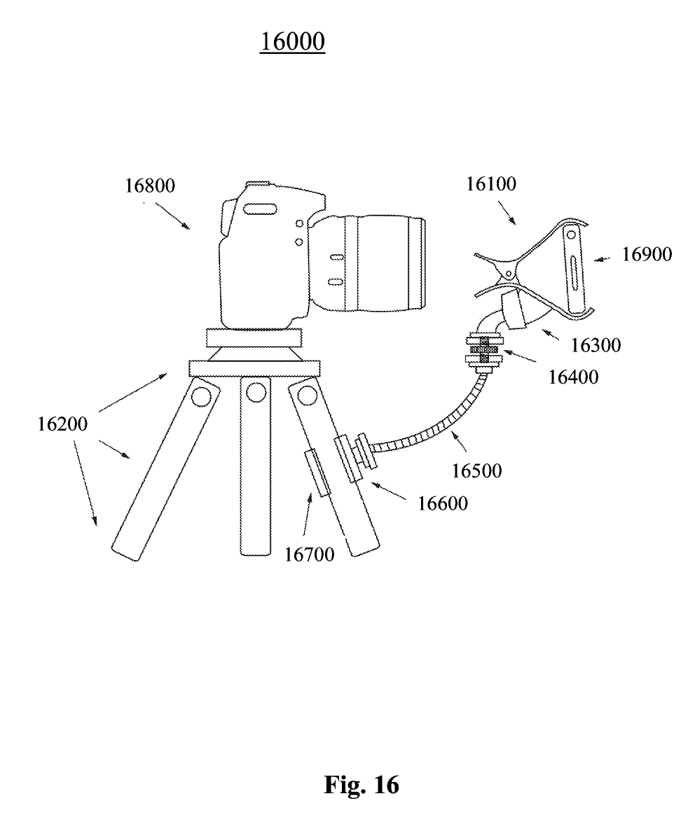

FIG. 16 is a side view of an exemplary embodiment of a system 16000, which can comprise a camera 16800 mounted to a tripod 16200. Camera 16800 can be a single lens reflex camera or any other type of camera. In certain exemplary embodiments, a gripper 16300 can be operatively coupled to a leg 16700 of tripod 16200 via a clamp 16600. Gripper 16300 can comprise a semi-rigid extension 16500. Semi-rigid extension 16500 can be adapted to support gripper 16300 and a PDA 16900 substantially without motion or deflection absent an outside force. Semi-rigid extension 16500 can be adjusted by a user to position and orient PDA 16900 according to desires of the user for photographs to be taken by camera 16800. Semi-rigid extension 16500 can be coupled to a jaw portion 16100 of gripper 16300 via a threaded coupling 16400. Gripper 16300 can define a threaded aperture, which can be adapted to be coupled to threaded coupling 16400. Jaw portion 16100 can be adapted to hold PDA 16900. When operatively mounted to tripod 16200, gripper 16300 can orient a face of PDA 16900 toward a subject in the viewfinder of camera 16800.

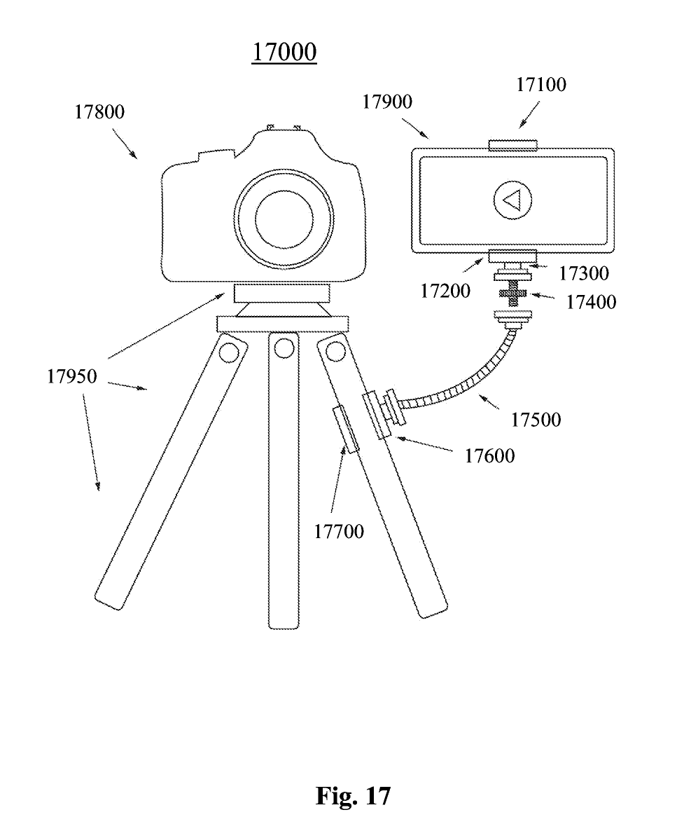

FIG. 17 is a front view of an exemplary embodiment of a system 17000, which can comprise a camera 17800 mounted to a tripod 17950. Camera 17800 can be a single lens reflex camera or any other type of camera. In certain exemplary embodiments, a gripper 17300 can be operatively coupled to a leg 17700 of tripod 17950 via a clamp 17600. Gripper 17300 can comprise a semi-rigid extension 17500. Semi-rigid extension 17500 can be adapted to support gripper 17300 and a PDA 17900 substantially without motion or deflection absent an outside force. Semi-rigid extension 17500 can be adjusted by a user to position and orient PDA 17900 according to desires of the user for photographs to be taken by camera 17800. Gripper 17300 can comprise a first jaw 17100 and a second jaw 17200. Semi-rigid extension 17500 can be coupled to a second jaw 17200 via a threaded coupling 17400. Gripper 17300 can define a threaded aperture, which can be adapted to be coupled to threaded coupling 17400. First jaw 17100 and second jaw 17200 can be adapted to hold PDA 17900. When operatively mounted to tripod 17950, gripper 17300 can orient a face of PDA 17900 toward a subject in the viewfinder of camera 17800.

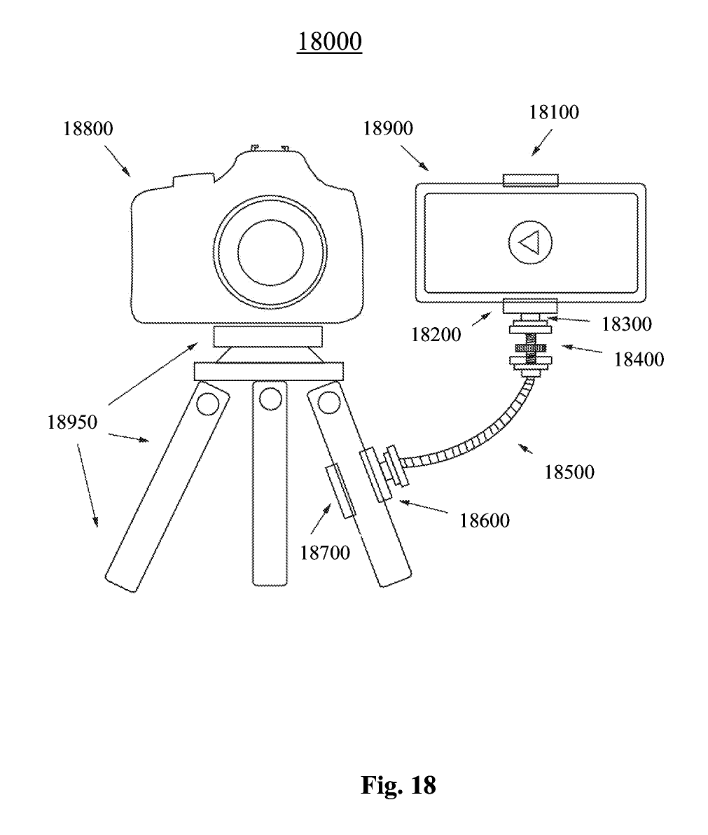

FIG. 18 is a front view of an exemplary embodiment of a system 18000, which can comprise a camera 18800 mounted to a tripod 18950. Camera 18800 can be a single lens reflex camera or any other type of camera. In certain exemplary embodiments, a gripper 18300 can be operatively coupled to a leg 18700 of tripod 18950 via a clamp 18600. Gripper 18300 can comprise a semi-rigid extension 18500. Semi-rigid extension 18500 can be adapted to support gripper 18300 and a PDA 18900 substantially without motion or deflection absent an outside force. Semi-rigid extension 18500 can be adjusted by a user to position and orient PDA 18900 according to desires of the user for photographs to be taken by camera 18800. Gripper 18300 can comprise a first jaw 18100 and a second jaw 18200. Semi-rigid extension 18500 can be coupled to second jaw 18200 via a threaded coupling 18400. Gripper 18300 can define a threaded aperture, which can be adapted to be coupled to threaded coupling 18400. First jaw 18100 and second jaw 18200 can be adapted to hold PDA 18900. When operatively mounted to tripod 18950, gripper 18300 can orient a face of PDA 18900 toward a subject in the viewfinder of camera 18800.

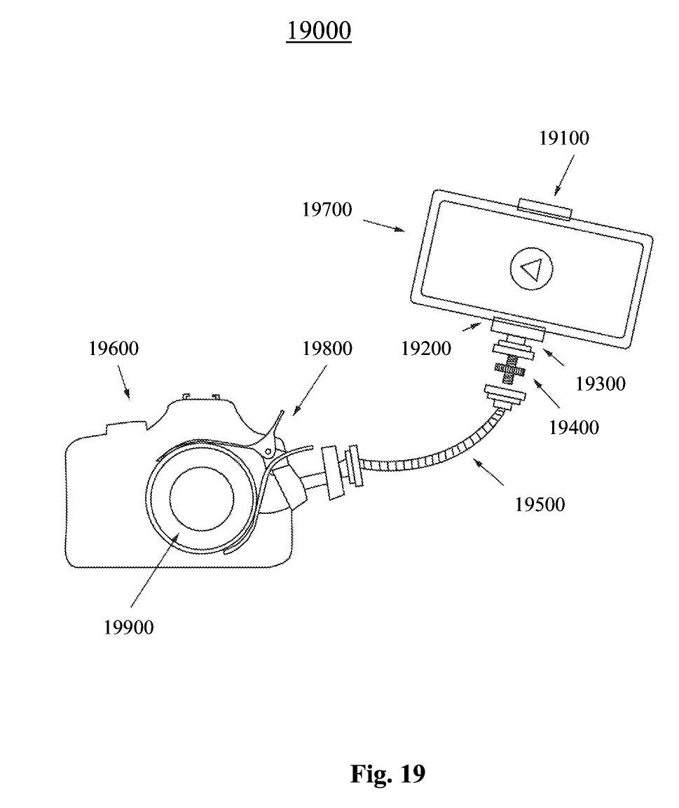

FIG. 19 is a front view of an exemplary embodiment of a system 19000, which can comprise a camera 19600 coupled to a gripper 19300. Camera 19600 can comprise a lens 19900, which can be coupled to gripper 19300 via a clamp 19800. Clamp 19800 can be coupled to a semi-rigid extension 19500. Semi-rigid extension 19500 can be adapted to support gripper 19300 and a PDA 19700 substantially without motion or deflection absent an outside force. Semi-rigid extension 19500 can be adjusted by a user to position and orient PDA 19700 according to desires of the user for photographs to be taken by camera 19600. Gripper 19300 can comprise a first jaw 19100 and a second jaw 19200. Semi-rigid extension 19500 can be coupled to second jaw 19200 via a threaded coupling 19400. Gripper 19300 can define a threaded aperture, which can be adapted to be coupled to threaded coupling 19400. First jaw 19100 and second jaw 19200 can be adapted to hold PDA 19700. When operatively mounted to camera 19600, gripper 19300 can orient a face of PDA 19700 toward a subject in the viewfinder of camera 19600.

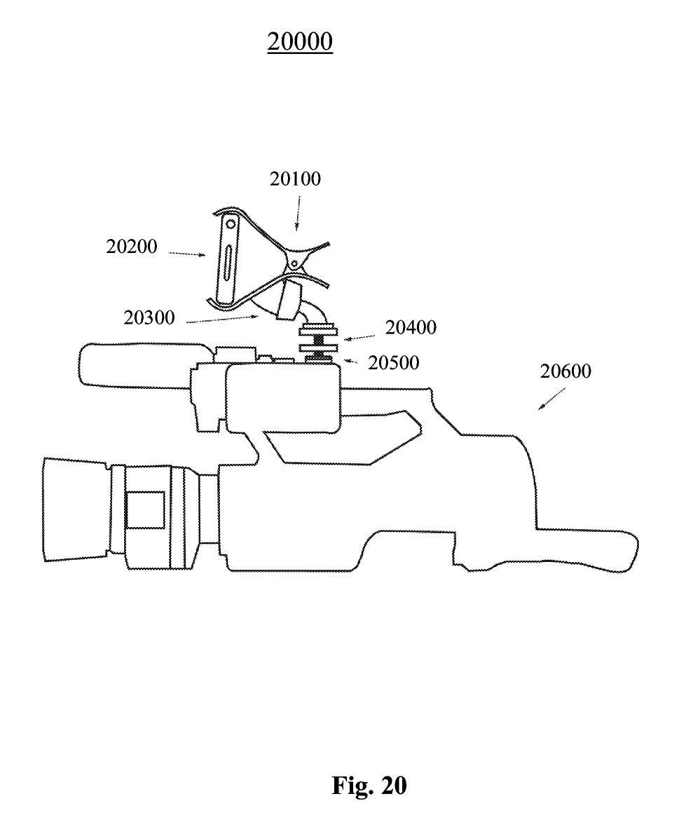

FIG. 20 is a side view of an exemplary embodiment of a system 20000, which can comprise a movie camera 20600 operatively coupled to a gripper 20100. Gripper 20100 can be coupled to a PDA 20200, which can be adapted for use in rendering an image and/or video causing a subject being filmed by movie camera 20600 to face and look at PDA 20200, thereby improving movie results. In certain exemplary embodiments, PDA 20200 can be adapted to automatically receive and/or transmit images and/or video from movie camera 20600. In certain exemplary embodiments, PDA 20200 can transmit images and/or video from movie camera 20600 to a memory device via a network. Gripper 20100 can comprise an elbow assembly 20300 and a camera mount 20400. Camera mount 20400 can be adapted to be coupled to a hot shoe 20500 of movie camera 20600.

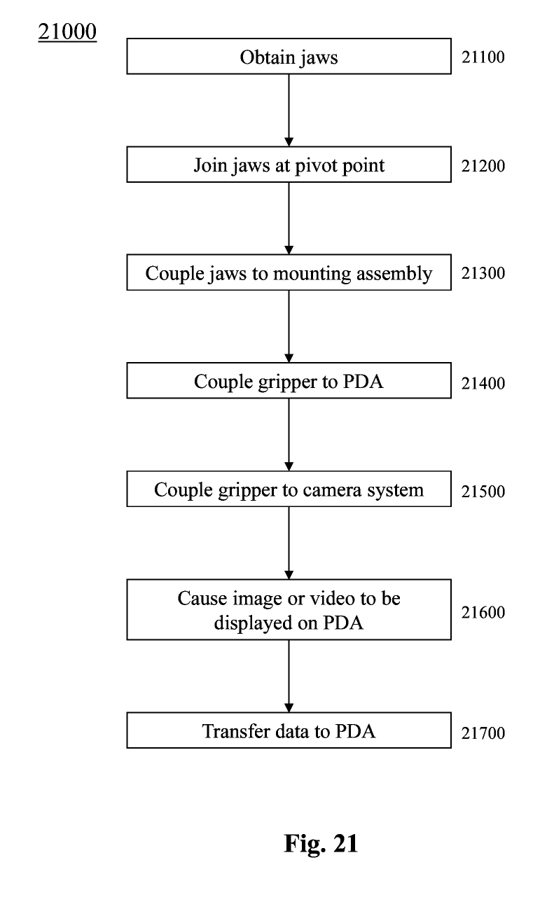

FIG. 21 is a flowchart of an exemplary embodiment of a method 21000. At activity 21100, a set of jaws (i.e., a first jaw and a second jaw) can be obtained and/or provided. The set of jaws can be made out of any suitable material such as aluminum, steel, stainless steel, vinyl polymers, polyvinylchloride, polycarbonate, polysulphone, polyarylene, a fluorinated polymer (Teflon® and the like), polyvinyl butyral, polyester, polyamic polymers, polyimide polymers, polydimethylsiloxane, and/or hydroxylated polyesters, etc. The set of jaws can be formed, carved, or machined to provide a desired size and shape.

At activity 21200, the first jaw and the second jaw can be joined at a pivot point. The first jaw and second jaw can be opened via a user by moving a grip end of the first jaw toward the grip end of the second jaw, thereby causing motion of the grip end of the first jaw and the grip end of the second jaw via the pivot point. At activity 21300, the jaws can be coupled to a mounting assembly to form a gripper. At activity 21400, the gripper can be coupled to a PDA. The set of jaws can be adapted to releasably couple the PDA to a camera system such that a face of the PDA is visible to a subject in a viewfinder of the camera system.

At activity 21500, the gripper can be coupled to, and/or caused to be coupled to a camera system. At activity 21600, an image and/or video can be caused to be displayed by the PDA. The subject can be caused to view an image and/or video on the PDA.

At activity 21700, data can be transferred from the camera to the PDA and/or the PDA to an information device coupled to a network. In certain exemplary embodiments, the camera can be communicatively coupled to the PDA via a wired and/or wireless interface. The PDA can be communicatively coupled to a network, such as the Internet, via a wireless signal. The PDA can be adapted to automatically transfer images obtained from the camera to an information device and/or a memory device coupled to the network. In certain exemplary embodiments, a camera system can automatically transfer images and/or video to the PDA and/or the PDA can automatically transfer images and/or video from the camera system to a memory device via a network.

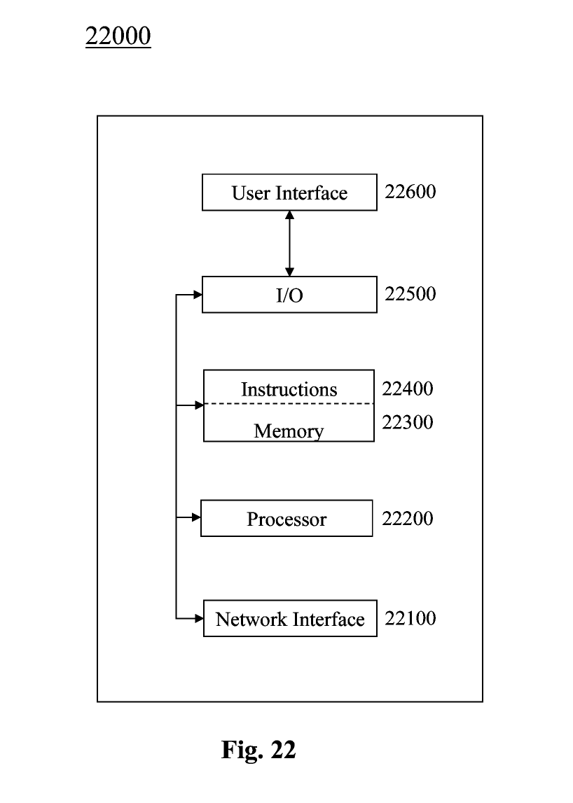

FIG. 22 is a block diagram of an exemplary embodiment of an information device 22000, which in certain operative embodiments can comprise, for example, PDA 1400 of FIG. 1. Information device 22000 can comprise any of numerous circuits and/or components, such as for example, one or more network interfaces 22100, one or more processors 22200, one or more memories 22300 containing instructions 22400, one or more input/output (I/O) devices 22500, and/or one or more user interfaces 22600 coupled to I/O device 22500, etc.

In certain exemplary embodiments, via one or more user interfaces 22600, such as a graphical user interface and/or a touch screen, a user can view a rendering of information related to photographs and/or information described herein.

### DEFINITIONS

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.

a—at least one.

activity—an action, act, step, and/or process or portion thereof.

adapted to—made suitable or fit for a specific use or situation.

adapter—a device used to effect operative compatibility between different parts of one or more pieces of an apparatus or system.

and/or—either in conjunction with or in alternative to.

aperture—an opening.

apparatus—an appliance or device for a particular purpose.

automatically—acting or operating in a manner essentially independent of external influence or control. For example, an automatic light switch can turn on upon “seeing” a person in its view, without the person manually operating the light switch.

camera—a device comprising a lens system, the device adapted to capture an image of something viewed via the lens system.

can—is capable of, in at least some embodiments.

cause—to produce an effect.

comprising—including but not limited to.

connect—to join or fasten together.

couple—to join, connect, and/or link together.

coupleable—capable of being joined, connected, and/or linked together.

device—a machine, manufacture, and/or collection thereof.

elbow assembly—a system having a bend or angle and adapted to couple a gripper to a camera mount.

face—a user interface screen of a personal digital assistant, such as a touchscreen.

grip end—an extreme portion of a jaw adapted to contact and restrain a personal digital assistant.

gripper—a system adapted to be releasably coupled to a personal digital assistant.

hand-grip—an extreme portion of a jaw adapted to be compressed by a human hand to expand grip ends of a gripper.

haptic—involving the human sense of kinesthetic movement and/or the human sense of touch. Among the many potential haptic experiences are numerous sensations, body-positional differences in sensations, and time-based changes in sensations that are perceived at least partially in non-visual, non-audible, and non-olfactory manners, including the experiences of tactile touch (being touched), active touch, grasping, pressure, friction, traction, slip, stretch, force, torque, impact, puncture, vibration, motion, acceleration, jerk, pulse, orientation, limb position, gravity, texture, gap, recess, viscosity, pain, itch, moisture, temperature, thermal conductivity, and thermal capacity.

hot shoe—a bracket on a camera body that provides support and electrical contact for an electronic flash attachment.

image—a physical likeness or representation of a person, animal, or thing, photographed, painted, sculptured, or otherwise made visible.

information device—any device capable of processing data and/or information, such as any general purpose and/or special purpose computer, such as a personal computer, workstation, server, minicomputer, mainframe, supercomputer, computer terminal, laptop, wearable computer, and/or Personal Digital Assistant (PDA), mobile terminal, Bluetooth device, communicator, “smart” phone (such as a Treo-like device), messaging service (e.g., Blackberry) receiver, pager, facsimile, cellular telephone, a traditional telephone, telephonic device, a programmed microprocessor or microcontroller and/or peripheral integrated circuit elements, an ASIC or other integrated circuit, a hardware electronic logic circuit such as a discrete element circuit, and/or a programmable logic device such as a PLD, PLA, FPGA, or PAL, or the like, etc. In general any device on which resides a finite state machine capable of implementing at least a portion of a method, structure, and/or or graphical user interface described herein may be used as an information device. An information device can comprise components such as one or more network interfaces, one or more processors, one or more memories containing instructions, and/or one or more input/output (I/O) devices, one or more user interfaces coupled to an I/O device, etc.

input/output (I/O) device—any sensory-oriented input and/or output device, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, and/or tactile pad, potentially including a port to which an I/O device can be attached or connected.

install—to connect or set in position and prepare for use.

jaw—either of two opposed hinged parts in a mechanical device.

lens—a piece of glass or plastic installed in a camera and shaped so as to focus or spread light rays that pass through it for the purpose of forming an image, the image capable of being transferred by the camera to photographic film and/or a digital image.

machine instructions—directions adapted to cause a machine, such as an information device, to perform one or more particular activities, operations, or functions. The directions, which can sometimes form an entity called a “processor”, “kernel”, “operating system”, “program”, “application”, “utility”, “subroutine”, “script”, “macro”, “file”, “project”, “module”, “library”, “class”, and/or “object”, etc., can be embodied as machine code, source code, object code, compiled code, assembled code, interpretable code, and/or executable code, etc., in hardware, firmware, and/or software.

machine readable medium—a physical structure from which a machine can obtain data and/or information. Examples include a memory, punch cards, etc.

may—is allowed and/or permitted to, in at least some embodiments.

memory device—an apparatus capable of storing analog or digital information, such as instructions and/or data. Examples include a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. The memory device can be coupled to a processor and/or can store instructions adapted to be executed by processor, such as according to an embodiment disclosed herein.

method—a process, procedure, and/or collection of related activities for accomplishing something.

move—to change from one position to another.

network—a communicatively coupled plurality of nodes. A network can be and/or utilize any of a wide variety of sub-networks, such as a circuit switched, public-switched, packet switched, data, telephone, telecommunications, video distribution, cable, terrestrial, broadcast, satellite, broadband, corporate, global, national, regional, wide area, backbone, packet-switched TCP/IP, Fast Ethernet, Token Ring, public Internet, private, ATM, multi-domain, and/or multi-zone sub-network, one or more Internet service providers, and/or one or more information devices, such as a switch, router, and/or gateway not directly connected to a local area network, etc.

network interface—any device, system, or subsystem capable of coupling an information device to a network. For example, a network interface can be a telephone, cellular phone, cellular modem, telephone data modem, fax modem, wireless transceiver, Ethernet card, cable modem, digital subscriber line interface, bridge, hub, router, or other similar device.

orient—to adjust with relation to, or bring into due relation to something else.

personal digital assistant—an information device adapted to be held in a hand of a user. A personal digital assistant can be a smartphone, the HTC HD2, Apple iPhone, Apple iPod Touch, and Palm Pre, Palm Pre Plus, Palm Pixi, Palm Pixi Plus, Google Android, and/or any other handheld information device, etc.

pivot point—a pin or short shaft on the end of which something rests and turns, or upon and about which something rotates or oscillates.

plurality—the state of being plural and/or more than one.

predetermined—established in advance.

processor—a device and/or set of machine-readable instructions for performing one or more predetermined tasks. A processor can comprise any one or a combination of hardware, firmware, and/or software. A processor can utilize mechanical, pneumatic, hydraulic, electrical, magnetic, optical, informational, chemical, and/or biological principles, signals, and/or inputs to perform the task(s). In certain embodiments, a processor can act upon information by manipulating, analyzing, modifying, converting, transmitting the information for use by an executable procedure and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium IV series of microprocessor manufactured by the Intel Corporation of Santa Clara, California. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein.

provide—to furnish, supply, give, and/or make available.

receive—to get as a signal, take, acquire, and/or obtain.

relative—in relation to something else.

releasably—adapted to be substantially non-destructively separable.

render—to make perceptible to a human, for example as data, commands, text, graphics, audio, video, animation, and/or hyperlinks, etc., such as via any visual, audio, and/or haptic means, such as via a display, monitor, electric paper, ocular implant, cochlear implant, speaker, etc.

set—a related plurality.

signal—information, such as machine instructions for activities and/or one or more letters, words, characters, symbols, signal flags, visual displays, and/or special sounds, etc. having prearranged meaning, encoded as automatically detectable variations in a physical variable, such as a pneumatic, hydraulic, acoustic, fluidic, mechanical, electrical, magnetic, optical, chemical, and/or biological variable, such as power, energy, pressure, flowrate, viscosity, density, torque, impact, force, frequency, phase, voltage, current, resistance, magnetomotive force, magnetic field intensity, magnetic field flux, magnetic flux density, reluctance, permeability, index of refraction, optical wavelength, polarization, reflectance, transmittance, phase shift, concentration, and/or temperature, etc. Depending on the context, a signal and/or the information encoded therein can be synchronous, asychronous, hard real-time, soft real-time, non-real time, continuously generated, continuously varying, analog, discretely generated, discretely varying, quantized, digital, broadcast, multicast, unicast, transmitted, conveyed, received, continuously measured, discretely measured, processed, encoded, encrypted, multiplexed, modulated, spread, de-spread, demodulated, detected, demultiplexed, decrypted, and/or decoded, etc.

store—to place, hold, and/or retain data, typically in a memory.

substantially—to a great extent or degree.

support—to bear the weight of, especially from below.

system—a collection of mechanisms, devices, machines, articles of manufacture, processes, data, and/or instructions, the collection designed to perform one or more specific functions.

threaded—comprising helical grooves or ridges.

tripod—a three-legged stand or support.

user—a human.

user interface—any device for rendering information to a user and/or requesting information from the user. A user interface includes at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.

via—by way of and/or utilizing.

video—moving images stored as a sequence of static images (called “frames”) representing snapshots of a scene, taken at regularly spaced time intervals, e.g., 50 frames per second.

view—to see.

viewfinder—a part of a camera through which a photographer looks to compose, and in many cases to focus, an image to be photographed.

weight—a value indicative of importance.

### NOTE

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:

there is no requirement for the inclusion of any particular described or illustrated characteristic, function, activity, or element, any particular sequence of activities, or any particular interrelationship of elements;

no characteristic, function, activity, or element is “essential”;

any elements can be integrated, segregated, and/or duplicated;

any activity can be repeated, any activity can be performed by multiple entities, and/or any activity can be performed in multiple jurisdictions; and

any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A system comprising:
a gripper, said gripper adapted to releasably couple a personal digital assistant to a camera system via a first jaw and a second jaw, said first jaw and said second jaw comprising a grip end and a hand-grip end, said first jaw and said second jaw coupled at a pivot point, said pivot point adapted to cause an increased separation between said grip end of said first jaw and said grip end of said second jaw when a user moves said hand-grip end of said first jaw toward said hand-grip end of said second jaw; said gripper adapted to orient said personal digital assistant relative to said camera system such that a face of said personal digital assistant is viewable by a person viewed via a viewfinder of said camera system.

2. The system of claim 1, further comprising:
said camera system.

3. The system of claim 1, wherein:
said gripper is adapted to couple to said camera system via a hot shoe of a camera comprised by said camera system.

4. The system of claim 1, wherein:
said gripper is adapted to couple to said camera system via a hot shoe of a camera comprised by said camera system; and
said gripper comprises an elbow assembly coupled to said second jaw.

5. The system of claim 1, wherein:
said gripper comprises an elbow assembly coupled to said second jaw, said elbow assembly comprising an elbow, a swivel joint, and a gripper base, said swivel joint adapted to be turned by a user to orient said personal digital assistant relative to said person viewed via said viewfinder.

6. The system of claim 1, wherein:
said gripper is adapted to couple to said camera system via a tripod mount of a camera comprised by said camera system.

7. The system of claim 1, wherein:
said gripper is adapted to be releasably coupled to a tripod mount of a camera comprised by said camera system via a threaded coupling.

8. The system of claim 1, wherein:
said gripper is adapted to be releasably coupled to a tripod mount of a camera comprised by said camera system via a threaded coupling; and
said gripper defines a threaded aperture adapted to be releasably coupled to said threaded coupling.

9. The system of claim 1, wherein:
said gripper is adapted to couple to said camera system via a clamp adapted to be releasably coupled to a tripod comprised by said camera system.

10. The system of claim 1, wherein:
said gripper is adapted to couple to said camera system via a clamp adapted to be releasably coupled to a lens of said camera system.

11. The system of claim 1, wherein:
said camera system automatically transfers images to said personal digital assistant.

12. The system of claim 1, wherein:
said camera system automatically transfers images to said personal digital assistant; and
said personal digital assistant automatically transfers images from said camera system to a memory device via a network.

13. The system of claim 1, wherein:
said camera system comprises a movie camera.

14. A method comprising a plurality of activities, comprising:
coupling a set of jaws at a pivot point, said set of jaws comprising a first jaw and a second jaw, said first jaw and said second jaw adapted to releasably couple a personal digital assistant to a camera system such that a face of said personal digital assistant is visible to a subject in a viewfinder of said camera system.

15. The method of claim 14, further comprising:
causing said personal digital assistant to be coupled to said camera system.

16. The method of claim 14, wherein:
providing said set of jaws to a user of said camera system.

17. The method of claim 14, further comprising:
causing said subject to view an image or video on said personal digital assistant.
